(19) United States
(12) Patent Application Publication
(10) Pub. No.: US 2012/0088129 A1
(43) Pub. Date: Apr. 12, 2012

(54) SECONDARY BATTERY

(76) Inventors: Mayumi Kaneda, Osaka (JP); Takuhiro Nishimura, Osaka (JP); Masanori Sumihara, Osaka (JP)

(21) Appl. No.: 13/378,219

(22) PCT Filed: Apr. 22, 2011
(86) PCT No.: PCT/JP2011/002374

§ 371 Date: Dec. 14, 2011

(30) Foreign Application Priority Data
Apr. 28, 2010 (JP) 2010-103328
May 31, 2010 (JP) 2010-123985
Jun. 29, 2010 (JP) 2010-147082

(51) Int. Cl. H01M 10/52; H01M 10/34

(52) U.S. Cl. 429/59

(57) ABSTRACT

A secondary battery including an electrode group 11 which is formed by winding or stacking a positive electrode plate 6 and a negative electrode plate 9 with separators 10a, 10b interposed therebetween, and is sealed in an exterior package 14 together with a nonaqueous electrolyte, wherein the positive electrode plate 6 includes a positive electrode mixture layer 5 formed on a positive electrode current collector 4, the negative electrode plate 9 includes a negative electrode mixture layer 8 formed on a negative electrode current collector 7, a gas adsorbing layer 19 including a binder and a structural material 16 made of inorganic oxide is formed on a surface of at least one of the positive electrode mixture layer 5 or the negative electrode mixture layer 8, and a gas adsorbent 18 is held in a pore 17 formed in the gas adsorbing layer 19.

### TECHNICAL FIELD

The present invention relates to secondary batteries represented by lithium-ion batteries.

### BACKGROUND ART

In recent years, as the size and the weight of portable electronic devices such as mobile phones, laptop personal computers, digital still cameras, and digital video cameras have decreased, light-weight, thin, high-capacity secondary batteries have been in demand as power sources of such portable electronic devices.

However, when gas is generated in a secondary battery, battery swelling may occur. In addition, due to a large increase in power consumption of the portable electronic devices, use under a high-temperature environment, or the like, gas tends to be easily generated due to, for example, decomposition of a nonaqueous electrolyte, and the battery swelling becomes a more serious problem.

In Patent Document 1, a secondary battery is described, wherein in order to reduce decomposition of a nonaqueous electrolyte, zeolite having water absorbency is contained in an active material and in the electrolyte.

Moreover, in Patent Document 2, a secondary battery is described, wherein a separator base material contains a gas-absorbing agent.

### CITATION LIST

### Patent Document

PATENT DOCUMENT 1: Japanese Patent Publication No. H11-260416

PATENT DOCUMENT 2: Japanese Patent Publication No. 2008-146963

### SUMMARY OF THE INVENTION

### Technical Problem

However, in the secondary battery described in Patent Document 1, an additive (zeolite) which does not contribute to battery reaction is contained in the active material and in the electrolyte. This may inhibit intended reaction of the battery, and may degrade battery characteristics.

Moreover, in the secondary battery described in Patent Document 2, a gas adsorbent is contained in the separator base material. This may impair functions such as an electrolyte holding property which is a primary property of a separator and shut down characteristics by heat, and may degrade the battery characteristics.

In view of the foregoing, the present invention has been devised. It is a major objective of the present invention to provide a nonaqueous electrolyte secondary battery in which battery swelling is reduced without degrading the battery characteristics.

### Solution to the Problem

To solve the problems discussed above, an example secondary battery of the present invention includes an electrode group which is formed by winding or stacking a positive electrode plate and a negative electrode plate with a separator interposed between the positive electrode plate and the negative electrode plate, and is sealed in an exterior package together with a nonaqueous electrolyte, wherein a gas adsorbing layer including a structural material made of inorganic oxide and a binder is formed on a surface of at least one of the positive electrode plate or the negative electrode plate, and a gas adsorbent is held in a pore formed in the gas adsorbing layer.

Another example secondary battery of the present invention includes an electrode group which is formed by winding or stacking a positive electrode plate and a negative electrode plate with a separator interposed between the positive electrode plate and the negative electrode plate, and is sealed in an exterior package together with a nonaqueous electrolyte, wherein the positive electrode plate includes a positive electrode mixture layer formed on a positive electrode current collector, the negative electrode plate includes a negative electrode mixture layer formed on a negative electrode current collector, at least one of the positive electrode current collector or the negative electrode current collector is made of a porous metal body, and a gas adsorbent is held in a pore formed in the porous metal body.

### Advantages of the Invention

According to the present invention, it is possible to provide a secondary battery including an electrode group which is formed by winding or stacking a positive electrode plate and a negative electrode plate with a separator interposed between the positive electrode plate and the negative electrode plate, and is sealed in an exterior package together with a nonaqueous electrolyte, wherein battery swelling is reduced without degrading the battery characteristics.

### BRIEF DESCRIPTION OF THE DRAWINGS

FIGS. 1A, 1B are views illustrating a configuration of a secondary battery of a first embodiment of the present invention, where FIG. 1A is an exploded perspective view, and FIG. 1B is a partially cut-away perspective view.

FIGS. 2A, 2B are cross-sectional views illustrating a configuration of part of a positive electrode plate and a negative electrode plate of the secondary battery of the first embodiment of the present invention.

FIG. 3 is a cross-sectional view illustrating a configuration of part of a positive electrode current collector of a second embodiment of the present invention.

FIG. 4 is a view illustrating a configuration of an electrode plate group of the second embodiment of the present invention.

### DESCRIPTION OF EMBODIMENTS

Embodiments of the present invention will be described in detail below with reference to the drawings. The present invention is not limited to the following embodiments. The embodiment can be modified without deviating from the effective scope of the present invention. The embodiment can be combined with other embodiments.

### First Embodiment

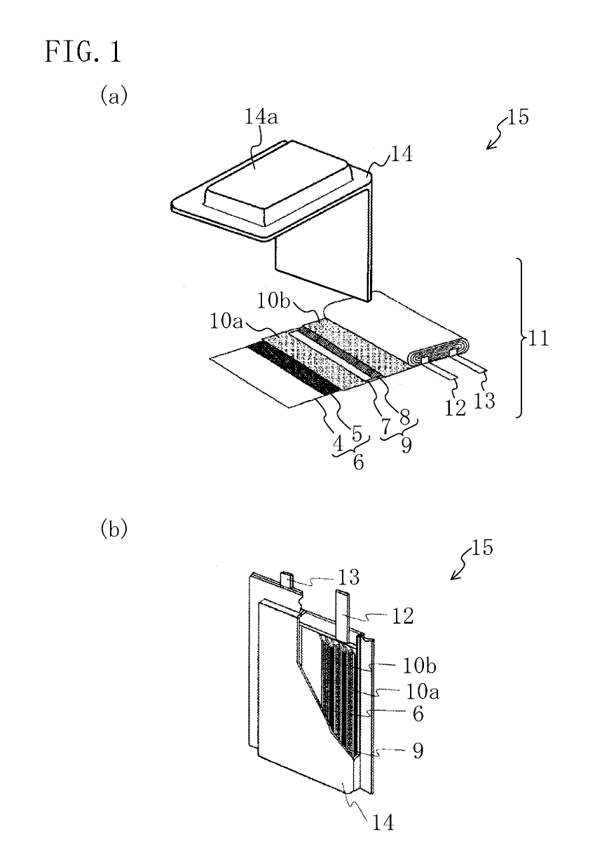

FIGS. 1A, 1B are views schematically illustrating a configuration of a secondary battery 15 of a first embodiment of the present invention, wherein FIG. 1A is an exploded perspective view, and FIG. 1B is a partially cut-away perspective view. Note that in the present embodiment, a flat laminate secondary battery will be described as an example, but the present invention is not limited to the embodiment, and is also applicable to, for example, cylindrical secondary batteries, rectangular secondary batteries, etc.

As illustrated in FIGS. 1A, 1B, the secondary battery 15 of the present embodiment includes an electrode group 11 which is formed by winding a positive electrode plate 6 and a negative electrode plate 9 with separators 10a, 10b interposed between the positive electrode plate 6 and the negative electrode plate 9, and then by pressing the wound plates into a flat shape, and is sealed in an exterior package 14 together with a nonaqueous electrolyte (not shown). Here, the positive electrode plate 6 includes a positive electrode mixture layer 5 formed on a positive electrode current collector 4, and the negative electrode plate 9 includes a negative electrode mixture layer 8 formed on a negative electrode current collector 7. A positive electrode lead 12 and a negative electrode lead 13 are welded to the positive electrode current collector 4 and the negative electrode current collector 7, respectively, and are led from an end face of the electrode group 11 to the outside of the exterior package 14. The exterior package 14 is made of an aluminum material. A thermoplastic resin layer such as polypropylene is formed on a surface of the exterior package 14 accommodating the electrode group 11. The exterior package 14 includes space 14a formed by compression molding in advance to accommodate the electrode group 11, and the electrode group 11 is accommodated in the space 14a. After the flat electrode group 11 is accommodated in the space 14a of the exterior package 14, an outer circumference of an opening of the exterior package 14 is heated to weld thermoplastic resin, thereby sealing the opening. Moreover, after a predetermined amount of the nonaqueous electrolyte is poured through an inlet (not shown) of the exterior package 14 into the exterior package 14, the inlet is heated to weld the thermoplastic resin, thereby sealing the inlet. The flat laminate secondary battery 15 is thus obtained.

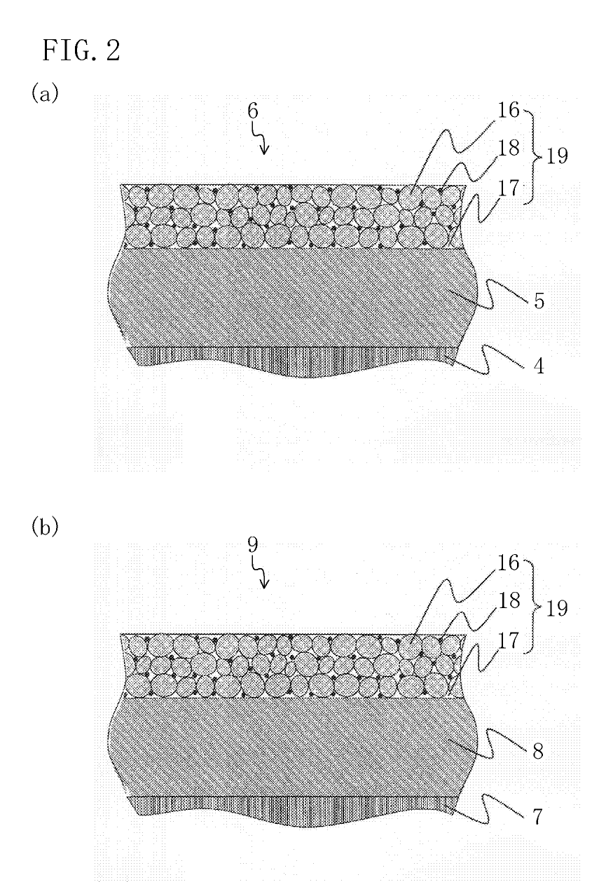

FIGS. 2A, 2b are cross-sectional views schematically illustrating configurations of part of the positive electrode plate 6 and part of the negative electrode plate 9 of the secondary battery 15 of the present embodiment, respectively.

As illustrated in FIGS. 2A, 2B, on surfaces of the positive electrode mixture layer 5 and the negative electrode mixture layer 8, a gas adsorbing layer 19 including a structural material 16 made of inorganic oxide and a binder (not shown) is formed. A gas adsorbent 18 is held in a pore 17 formed in the gas adsorbing layer 19.

Here, the gas adsorbing layer 19 can be formed, for example, as follows. First, the structural material 16 such as silica powder and the binder such as polyvinylidene fluoride (PVdF) are added to a dispersion medium such as N-methyl-2-pyrrolidone, and are mixed and dispersed in a dispersion device such as a planetary mixer, and then the gas adsorbent 18 such as active carbon is further added, and is also mixed and dispersed in the dispersion device to prepare a gas adsorbing layer coating. Next, the gas adsorbing layer coating is applied to the surfaces of the positive electrode mixture layer 5 and the negative electrode mixture layer 8 by, for example, die coating, gravure coating, blade coating, or the like, and the applied coating is dried. The gas adsorbing layer 19 can thus be formed.

When the gas adsorbing layer 19 is thus formed on the surfaces of the positive electrode mixture layer 5 and the negative electrode mixture layer 8, gas generated in the secondary battery can be adsorbed without inhibiting the intended reaction of the battery. Moreover, since the gas adsorbing layer 19 is formed on the surfaces of the positive electrode mixture layer 5 and the negative electrode mixture layer 8, gas generated due to an active material can be efficiently adsorbed at a point closest to the source of generation of the gas. Furthermore, since the gas adsorbing layer 19 has a structure in which the structural material is bound by the binder, the pore 17 is formed in the gas adsorbing layer 19, and the gas adsorbent 18 is held in the pore 17. Therefore, even when the gas generated in the battery is adsorbed by the gas adsorbent 18, the gas adsorbing layer 19 does not swell. In addition, the gas adsorbing layer 19 can be thinly formed on the surfaces of the positive electrode mixture layer 5 and the negative electrode mixture layer 8 by coating, so that a decrease in energy density of the battery can be limited to a lesser extent. Thus, when the gas adsorbing layer 19 is formed on the surfaces of the positive electrode mixture layer 5 and the negative electrode mixture layer 8, it is possible to from a secondary battery in which battery swelling is reduced without degrading the battery characteristics.

In the present embodiment, the gas adsorbing layer 19 is formed on the surfaces of the positive electrode mixture layer 5 and the negative electrode mixture layer 8. However, the gas adsorbing layer 19 may be formed on the surface of at least one of the positive electrode mixture layer 5 or the negative electrode mixture layer 8. Alternatively, the gas adsorbing layer 19 may be formed on only one surface or both surfaces of the positive electrode mixture layer 5 and/or the negative electrode mixture layer 8.

As the structural material 16 of the gas adsorbing layer 19, for example, inorganic oxide such as alumina or magnesia may be used instead of silica.

The binder of the gas adsorbing layer 19 is preferably a material resistant to the electrolyte, and for example, polytetrafluoroethylene (PTFE) may be used instead of polyvinylidene fluoride (PVdF).

As the gas adsorbent 18, a material can be accordingly selected based on the type of gas generated in the secondary battery, and for example, silica gel, zeolite, metal stearate, hydrotalcite, hydrogen-absorbing alloy, activated alumina, transition metal oxide, soda lime, ascarite, calcium oxide, magnesium oxide, or the like may be used instead of active carbon.

Here, the thickness of the gas adsorbing layer 19 is preferably in the range from 4 μm to 20 μm. If the thickness of the gas adsorbing layer 19 is smaller than 4 μm, it is difficult to uniformly form the gas adsorbing layer 19, and the strength of the gas adsorbing layer 19 is insufficient, so that the gas adsorbing layer 19 may fall off the surface of the positive electrode mixture layer 5 or the negative electrode mixture layer 8. In contrast, if the thickness of the gas adsorbing layer 19 is larger than 20 μm, the thickness of the positive electrode plate 6 and the thickness of the negative electrode plate 9 are large, so that it is difficult to obtain a high-capacity secondary battery. Note that the thickness of the gas adsorbing layer 19 is more preferably in the range from 5 μm to 15 μm.

Structures, materials, etc. of the positive electrode plate 6, the negative electrode plate 9, the nonaqueous electrolyte, and the separators 10a, 10b included in the secondary battery 15 may be, but not particularly limited to, those prepared/fabricated in the following method.

The positive electrode plate 6 is fabricated by forming the positive electrode mixture layer 5 on one or both surfaces of the positive electrode current collector 4 made of, for example, aluminum foil having a thickness of 5 μm-30 μm. The positive electrode mixture layer 5 can be fabricated by mixing and dispersing a positive electrode active material, a conductive material, and a binder in a dispersion medium by a dispersion device such as a planetary mixer to prepare a positive electrode mixture coating, and by applying the positive electrode mixture coating to the surface(s) of the positive electrode current collector 4, drying the applied coating, and rolling the dried coating. As the positive electrode active material, for example, lithium cobaltate, lithium nickelate, or lithium manganate may be used. As the conductive material, for example, carbon black such as acetylene black, ketjen black, or graphite may be used. As the binder, for example, polyvinylidene fluoride (PVdF), or polytetrafluoroethylene (PTFE) may be used.

The negative electrode plate 9 is fabricated by forming the negative electrode mixture layer 8 on one or both surfaces of the negative electrode current collector 7 made of, for example, rolled foil having a thickness of 5 μm-25 μm. The negative electrode mixture layer 8 can be fabricated by mixing and dispersing a negative electrode active material, a binder, and a conductive material as needed in a dispersion medium by a dispersion device such as a planetary mixer to prepare a negative electrode mixture coating, and by applying the negative electrode mixture coating to the surface(s) of the negative electrode current collector 7, drying the applied coating, and rolling the dried coating. As the active material for the negative electrode, for example, a silicon composite material such as graphite, or silicide may be used. As the binder, for example, polyvinylidene fluoride (PVdF) or styrene-butadiene copolymer rubber particle (SBR) may be used.

In the nonaqueous electrolyte, for example, a lithium compound such as LiPF₆ or LiBF₄ may be used as electrolyte salt, and for example, ethylene carbonate (EC) or dimethyl carbonate (DMC) may be used as a solvent.

As the separators 10a, 10b, for example, microporous films made of polyolefin-based resin such as polyethylene or polypropylene having a thickness of 10 μm-25 μm are preferably used.

### Second Embodiment

In the secondary battery of the first embodiment, the gas adsorbing layer 19 containing the structural material 16 made of inorganic oxide and the binder is formed on the surface of at least one of the positive electrode plate 6 or the negative electrode plate 9, so that it is possible to reduce battery swelling without degrading the battery characteristics. This advantage is obtained because the gas adsorbent 18 is held in the pore 17 formed in the gas adsorbing layer 19, and the gas adsorbing layer 19 does not swell even when the gas adsorbent 18 adsorbs gas generated in the battery.

The thickness of the gas adsorbing layer 19 can be reduced to about 4 μm-20 μm, but the gas adsorbing layer 19 itself is a component which does not contribute to the battery reaction, and thus providing the gas adsorbing layer 19 inevitably reduces the energy density of the secondary battery.

For this reason, the present inventors focused on a current collector made of a porous metal body, and found that when a gas adsorbent is held in a pore formed in the porous metal body, the same advantage as those in the case of providing the gas adsorbing layer 19 can be obtained. Since the current collector made of the porous metal body is an essential component included in an electrode plate, adding a gas adsorbing function to the current collector does not reduce the energy density of the secondary battery.

A configuration of a secondary battery of a second embodiment of the present invention will be described below with reference to the drawings.

The secondary battery of the present embodiment has a configuration similar to that of the secondary battery illustrated in FIGS. 1A, 1B. That is, an electrode group 11 formed by winding a positive electrode plate 6 and a negative electrode plate 9 with separators 10a, 10b interposed between the positive electrode plate 6 and a negative electrode plate 9 is sealed in an exterior package 14 together with a nonaqueous electrolyte (not shown). The positive electrode plate 6 includes a positive electrode mixture layer 5 formed on a positive electrode current collector 4, and the negative electrode plate 9 includes a negative electrode mixture layer 8 formed on a negative electrode current collector 7.

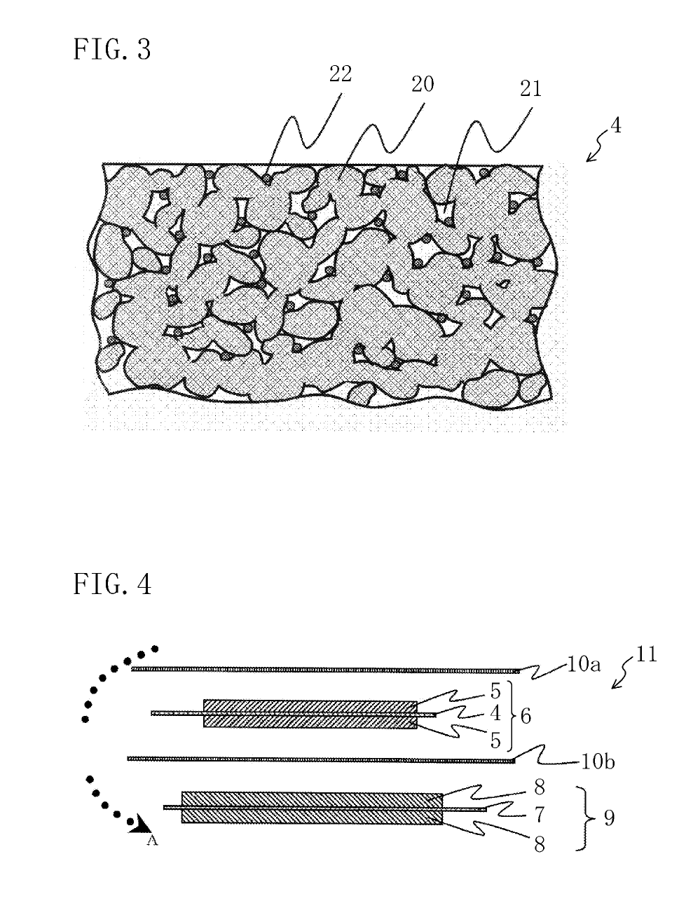

FIG. 3 is a cross-sectional view schematically illustrating a configuration of part of the positive electrode current collector 4 of the present embodiment. As illustrated in FIG. 3, the positive electrode current collector 4 includes a porous metal body 20. As the porous metal body 20, for example, a sintered metal body such as aluminum or an aluminum alloy is used. In the porous metal body 20, a pore 21 which is continuous in three dimensions is formed. In the pore 21 formed in the porous metal body 20, a gas adsorbent 22 is held.

The positive electrode current collector 4 holding the gas adsorbent 22 can be formed, for example, as described below. First, melt impregnation of the gas adsorbent 22 such as active carbon with resin such as polyethylene (PE) is performed at 130° C. Next, the resin and the porous metal body 20 are accommodated in a vacuum container, and the resin is heated in a nitrogen atmosphere to 500° C. In this way, it is possible to form the positive electrode current collector 4 in which the gas adsorbent 22 is held in the pore 21 formed in the porous metal body 20.

As described above, the positive electrode current collector 4 is made of the porous metal body 20, and the gas adsorbent 22 is held in the pore 21 formed in the porous metal body 20, so that it is possible to adsorb gas generated in the secondary battery due to charge and discharge without inhibiting the intended reaction of the battery. Moreover, the gas adsorbent 22 is held in the positive electrode current collector 4 supporting the positive electrode mixture layer, so that gas generated due to an active material can be efficiently adsorbed at a position closest to the source of generation of the gas. Furthermore, the gas adsorbent 22 is held in the pore 21 formed in the porous metal body 20 included in the positive electrode current collector 4, so that the positive electrode current collector 4 does not swell even when gas generated in the battery is adsorbed by the gas adsorbent 18. In addition, the gas adsorbent 22 is held in positive electrode current collector 4 which is an essential component of the electrode plate, so that adding a gas adsorbing function to the positive electrode current collector 4 does not reduce the energy density of the secondary battery. Thus, when the positive electrode current collector 4 is made of the porous metal body 20, and the gas adsorbent 22 is held in the pore 21 formed in the porous metal body 20, it is possible to form a secondary battery in which battery swelling is reduced without degrading the battery characteristics.

Here, as the positive electrode current collector 4, for example, a sintered metal body made of nickel or a nickel alloy may be used instead of the sintered metal body made of aluminum or an aluminum alloy.

Moreover, the thickness of the positive electrode current collector (porous metal body) 4 is preferably in the range from 10 μm to 40 μm. If the thickness of the positive electrode current collector 4 is smaller than 10 μm, it is difficult to form the positive electrode current collector 4 as the porous metal body 20, and at the same time, the strength as the positive electrode current collector 4 is insufficient, so that the positive electrode plate 6 may be torn in forming the positive electrode plate 6. In contrast, if the thickness of the positive electrode current collector 4 is larger than 40 μm, the thickness of the positive electrode plate 6 after forming the positive electrode mixture layer 5 is large, so that it is difficult to obtain a high-capacity secondary battery. The thickness of the positive electrode current collector 4 is more preferably in the range from 15 μm to 35 μm.

Moreover, the porosity of the positive electrode current collector (porous metal body) 4 is preferably in the range from 20% to 60%. If the porosity of the positive electrode current collector 4 is smaller than 20%, it is difficult to uniformly distribute the gas adsorbent 22 in the pore 21. In contrast, if the porosity of the positive electrode current collector 4 is larger than 60%, it is difficult to form the positive electrode current collector 4 as the porous metal body 20, and at the same time, the strength as the positive electrode current collector 4 is insufficient, so that the positive electrode plate 6 may be torn in forming the positive electrode plate 6. The porosity of the positive electrode current collector 4 is more preferably in the range from 25% to 55%.

Moreover, the pore size of the positive electrode current collector (porous metal body) 4 is preferably in the range from 1 μm to 5 μm. If the pore size of the positive electrode current collector 4 is smaller than 1 μm, it is difficult to uniformly distribute the gas adsorbent 22 in the pore 21. In contrast, if the pore size of the positive electrode current collector 4 is larger than 5 μm, it is difficult to form the positive electrode current collector 4 as the porous metal body 20, and at the same time, the strength as the positive electrode current collector 4 is insufficient, so that the positive electrode plate 6 may be torn in forming the positive electrode plate 6.

Note that in the present embodiment, the gas adsorbent 22 is held in the positive electrode current collector 4, but the present invention is not limited to the embodiment. At least one of the positive electrode current collector 4 or the negative electrode current collector 7 may be made of a porous metal body, and a gas adsorbent may be held in a pore formed in the porous metal body.

As the negative electrode current collector 7, for example, a porous metal body including a sintered metal body made of copper, or a copper alloy may be used. Moreover, as in the positive electrode current collector 4, the thickness of the negative electrode current collector (porous metal body) 7 is preferably in the range from 10 μm to 40 μm. Moreover, the porosity of the negative electrode current collector (porous metal body) 7 is preferably in the range from 20% to 60%, and the pore size of the negative electrode current collector 7 is preferably in the range from 1 μm to 5 μm.

As the gas adsorbent 22 in the present embodiment, a material can be accordingly selected based on the type of gas generated in the secondary battery, and for example, silica gel, zeolite, metal stearate, hydrotalcite, hydrogen-absorbing alloy, activated alumina, transition metal oxide, soda lime, ascarite, calcium oxide, magnesium oxide, or the like may be used instead of active carbon.

FIG. 4 is a view schematically illustrating the configuration of the electrode group 11 of the present embodiment, wherein the positive electrode plate 6 including the positive electrode mixture layer 5 formed on the positive electrode current collector 4 and the negative electrode plate 9 including the negative electrode mixture layer 8 formed on the negative electrode current collector 7 are wound in a direction indicated by an arrow A with the separators 10a, 10b interposed therebetween, and then, are rolled into a flat shape, thereby forming the flat electrode group 11.

Moreover, structures, materials, etc. of the positive electrode plate 6, the negative electrode plate 9, the nonaqueous electrolyte, and the separators 10a, 10b included in the secondary battery of the present embodiment may be, but not particularly limited to, those prepared/fabricated in the method described in the first embodiment.

Next, in order to evaluate the secondary battery of the present invention, secondary batteries are fabricated according to examples described below, and battery swelling and the cycle characteristics are evaluated.

Note that in first to fourth examples and a comparative example below, secondary batteries of the first embodiment are evaluated, and in fifth to eleventh examples and second to eighth comparative examples, secondary batteries of the second embodiment are evaluated.

### First Example

In a kneader, 100 parts by mass of lithium cobaltate as a positive electrode active material, 2 parts by mass of acetylene black as a conductive material, and 2 parts by mass of polyvinylidene fluoride (PVdF) as a binder were kneaded together with an appropriate amount of N-methyl-2-pyrrolidone to prepare a positive electrode mixture coating.

Next, the positive electrode mixture coating was applied to both surfaces of a positive electrode current collector 4 made of aluminum foil having a thickness of 12 μm and containing iron, and dried to fabricate a positive electrode plate base body having a 100 μm thick positive electrode mixture layer 5 on each surface of the positive electrode current collector 4. The positive electrode plate base body was pressed to a total thickness of 165 μm, thereby shaping the positive electrode mixture layer 5 on each surface of the positive electrode current collector 4 to have a thickness of 75 μm.

Next, 100 parts by mass of silica powder having an average particle size of 1.0 μm as a structural material 16, and 10 parts by mass of polyvinylidene fluoride as a binder were mixed in a stirrer together with an appropriate amount of N-methyl-2-pyrrolidone, and 2 parts by mass of active carbon as a gas adsorbent 18 was further added, and mixed in the stirrer to prepare a gas adsorbent layer coating. After the gas adsorbing layer coating was applied to both surfaces of the positive electrode mixture layer 5, and dried to form gas adsorbing layers 19 each having a thickness of 5 μm, slit processing was performed to fabricate a positive electrode plate 6.

In a kneader, 100 parts by mass of artificial graphite as a negative electrode active material, 2.5 parts by mass of styrene-butadiene copolymer rubber particle dispersion (40 mass % of a solid content) (1 parts by mass in terms of solid content of the binder) as a binder, and 1 parts by mass of carboxymethylcellulose as a thickening agent were stirred together with an appropriate amount of water to prepare a negative electrode mixture coating.

Next, the negative electrode mixture coating was applied to a negative electrode current collector 7 made of copper foil having a thickness of 8 μm, and dried to fabricate a negative electrode plate base body having a 100 μm thick negative electrode mixture layer 8 on each of surfaces of the negative electrode current collector 7. The negative electrode plate base body was pressed to a total thickness of 170 μm, thereby shaping the negative electrode mixture layer 8 on each surface of the negative electrode current collector 7 to have a thickness of 80 μm, and then slit processing was performed to fabricate a negative electrode plate 9.

The positive electrode plate 6 and the negative electrode plate 9 which were fabricated in the manner described above were wound with separators 10a, 10b interposed therebetween, thereby fabricating an electrode group 11. The electrode group 11 was accommodated in an exterior package 14 together with a nonaqueous electrolyte obtained by dissolving 1M of LiPF₆ and 3 parts by mass of VC in a mixed solvent of EC, DMC, and MEC, and an outer circumference of an opening of the exterior package 14 was sealed. A flat laminate battery 15 as illustrated in FIGS. 1A, 1B was thus fabricated.

### Second Example

A negative electrode plate 9 and a positive electrode mixture layer 5 were fabricated in a manner similar to that of the first example. Next, 100 parts by mass of silica powder having an average particle size of 1.0 μm as a structural material 16, and 10 parts by mass of polyvinylidene fluoride as a binder were mixed in a stirrer together with an appropriate amount of N-methyl-2-pyrrolidone, and 2 parts by mass of active carbon and 2 parts by mass of hydrogen-absorbing alloy as a gas adsorbent 18 were further added, and mixed in the stirrer to prepare a gas adsorbent layer coating. The gas adsorbing layer coating was applied to both surfaces of the positive electrode mixture layer 5, and dried to form gas adsorbing layers 19 each having a thickness of 5 μm. Moreover, an electrode group 11 was fabricated in a manner similar to that of the first example, and using the electrode group 11, a flat laminate battery 15 was fabricated.

### Third Example

A negative electrode plate 9 and a positive electrode mixture layer 5 were fabricated in a manner similar to that of the first example. Next, 100 parts by mass of silica powder having an average particle size of 1.0 μm as a structural material 16, and 10 parts by mass of polyvinylidene fluoride as a binder were mixed in a stirrer together with an appropriate amount of N-methyl-2-pyrrolidone, and 2 parts by mass of active carbon and 2 parts by mass of ascarite as a gas adsorbent 18 were further added, and mixed in the stirrer to prepare a gas adsorbent layer coating. The gas adsorbing layer coating was applied to both surfaces of the positive electrode mixture layer 5, and dried to form gas adsorbing layers 19 each having a thickness of 5 μm. Moreover, an electrode group 11 was fabricated in a manner similar to that of the first example, and using the electrode group 11, a flat laminate battery 15 was fabricated.

### Fourth Example

A negative electrode plate 9 and a positive electrode mixture layer 5 were fabricated in a manner similar to that of the first example. Next, 100 parts by mass of silica powder having an average particle size of 1.0 μm as a structural material 16, and 10 parts by mass of polyvinylidene fluoride as a binder were mixed in a stirrer together with an appropriate amount of N-methyl-2-pyrrolidone, and 2 parts by mass of hydrogen-absorbing alloy, 2 parts by mass of ascarite, and 2 parts by mass of active carbon as a gas adsorbent 18 were further added, and mixed in the stirrer to prepare a gas adsorbent layer coating. The gas adsorbing layer coating was applied to both surfaces of the positive electrode mixture layer 5, and dried to form gas adsorbing layers 19 each having a thickness of 7 μm. Moreover, an electrode group 11 was fabricated in a manner similar to that of the first example, and using the electrode group 11, a flat laminate battery 15 was fabricated.

### First Comparative Example

A negative electrode plate 9 and a positive electrode mixture layer 5 were fabricated in a manner similar to that of the first example. Note that gas adsorbing layers 19 such as those of the first example were not formed on surfaces of the positive electrode mixture layer 5. Moreover, an electrode group 11 was fabricated in a manner similar to that of the first example, and using the electrode group 11, a flat laminate battery 15 was fabricated.

Flat laminate batteries of the first to fourth examples and the first comparative example, 40 each, were fabricated, and were evaluated in the following manner.

As to the battery swelling amount, battery thicknesses of the flat laminate batteries 15 immediately after the fabrication and after 500 charge/discharge cycles were measured, and a difference between average values of the battery thicknesses was computed to obtain the battery swelling amount. Moreover, as to the capacity retention rate, under a charge/discharge condition in which the flat laminate batteries 15 were charged at a constant current of 560 mA until the voltage reached 4.2 V, charged at a constant voltage of 4.2 V until the current reached 40 mA, and then discharged at a constant current of 80 mA until the voltage reached 3 V, discharge capacity after the charge/discharge cycle was repeated 500 times was measured, and the ratio of the discharge capacity to the initial capacity was evaluated as the capacity retention rate. Moreover, in analysis of generated gas, after the 500 cycles were completed, the flat laminate batteries 15 were disassembled, and gas in the flat laminate batteries 15 was identified and, was subjected to quantitative analysis. Table 1 shows the results of the evaluation.

TABLE 1

| | Battery | Capacity | |
|---|---|---|---|
| | Swelling | Retention | |
| | Amount | Rate | |
| | After 500 | After 500 | |
| | Cycles (mm) | Cycles (%) | Generated Gas |
| 1st Example | 0.49 | 87 | H₂, CO₂ |
| 2nd Example | 0.33 | 89 | CO₂ |
| 3rd Example | 0.29 | 90 | H₂ |
| 4th Example | 0.13 | 92 | — |
| 1st Compar. Ex. | 1.57 | 75 | H₂, CO₂, CH₄, C₂H₆ |

The results in Table 1 show that in the first example, the battery swelling amount after the 500 cycles was reduced. This is probably because CH₄, C₂H₆ were adsorbed by the active carbon contained as the gas adsorbent 18 in the gas adsorbing layer 19. Moreover, in the second example, the battery swelling amount was reduced probably because CH₄, C₂H₆ were adsorbed by the active carbon contained as the gas adsorbent 18 in the gas adsorbing layer 19, and H₂ was adsorbed by the hydrogen-absorbing alloy contained as the gas adsorbent 18.

Further, in the third example, the battery swelling amount was reduced probably because CH₄, C₂H₆ were adsorbed by the active carbon contained as the gas adsorbent 18 in the gas adsorbing layer 19, and CO₂ was adsorbed by the ascarite contained as the gas adsorbent 18. Furthermore, in the fourth example, the battery swelling amount was further reduced probably because H₂, CH₄, C₂H₆, and CO₂ were adsorbed by the hydrogen-absorbing alloy, the ascarite, and the active carbon contained as the gas adsorbent 18 in the gas adsorbing layer 19.

From the results above, it was found that in the flat laminate batteries 15, providing the gas adsorbing layer 19 at least one of surfaces of the positive electrode plate 6 allowed the battery swelling amount after the 500 cycles to be reduced, and the capacity retention rate after the 500 cycles was also high.

Note that in the present example, evaluation was performed in the case where the thickness of the gas adsorbing layer 19 was 5 μm and in the case where the thickness of the gas adsorbing layer 19 was 7 μm, but similar advantages can be obtained in the case where the thickness of the gas adsorbing layer 19 is in the range from 4 μm to 20 μm.

### Fifth Example

In a kneader, 100 parts by mass of lithium cobaltate as a positive electrode active material, 2 parts by mass of acetylene black as a conductive material, and 2 parts by mass of polyvinylidene fluoride (PVdF) as a binder were kneaded together with an appropriate amount of N-methyl-2-pyrrolidone to prepare a positive electrode mixture coating.

As a positive electrode current collector 4, a porous metal body 20 obtained by sintering nickel powder was used, wherein the porous metal body 20 had a pore size of 1 μm, a porosity of 35%, and a thickness of 30 μm. Melt impregnation of the porous metal body 20 with polyethylene (PE) in which active carbon and hydrogen-absorbing alloy were dispersed as a gas adsorbent 22 was performed at 135° C., and then the porous metal body 20 was heated in a nitrogen atmosphere to 500° C. to fabricate the positive electrode current collector 4 in which the gas adsorbent 22 was held in a pore 21 of the porous metal body 20.

The positive electrode mixture coating was applied to both surfaces of the positive electrode current collector 4, and dried to fabricate a positive electrode plate base body having a 100 μm thickness positive electrode mixture layer 5 on each surface of the positive electrode current collector 4. The positive electrode plate base body was pressed to a total thickness of 165 μm, thereby forming the positive electrode mixture layer 5 on each surface of the positive electrode current collector 4 to have a thickness of 75 μm, and then slit processing was performed to fabricate a positive electrode plate 6.

In a kneader, 100 parts by mass of artificial graphite as a negative electrode active material, 2.5 parts by mass of styrene-butadiene copolymer rubber particle dispersion (40 mass % of a solid content) (1 parts by mass in terms of solid content of the binder) as a binder, and 1 parts by mass of carboxymethylcellulose as a thickening agent were stirred together with an appropriate amount of water to prepare a negative electrode mixture coating.

The negative electrode mixture coating was applied to a negative electrode current collector 7 made of copper foil having a thickness of 10 μm, and dried to fabricate a negative electrode plate base body having a 110 μm thickness negative electrode mixture layer 8 on each of surfaces of the negative electrode current collector 7. The negative electrode plate base body was pressed to a total thickness of 180 μm, thereby forming the negative electrode mixture layer 8 on each surface of the negative electrode current collector 7 to have a thickness of 85 μm, and then slit processing was performed to fabricate a negative electrode plate 9.

The positive electrode plate 6 and the negative electrode plate 9 which were fabricated in the manner described above were wound with separators 10a, 10b interposed therebetween, thereby fabricating an electrode group 11. The electrode group 11 was accommodated in an exterior package 14 together with a nonaqueous electrolyte obtained by dissolving 1M of LiPF₆ and 3 parts by mass of VC in a mixed solvent of EC, DMC, and MEC, and an outer circumference of an opening of the exterior package 14 was sealed. A flat laminate battery 15 as illustrated in FIGS. 1A, 1B was thus fabricated.

### Sixth Example

A positive electrode mixture coating and a negative electrode mixture coating were prepared in a manner similar to that of the fifth example.

The positive electrode mixture coating was applied to both surfaces of a positive electrode current collector 4 made of aluminum foil having a thickness of 15 μm, and dried to fabricate a positive electrode plate base body having a 100 μm thickness positive electrode mixture layer 5 on each surface of the positive electrode current collector 4. The positive electrode plate base body was pressed to a total thickness of 165 μm, thereby forming the positive electrode mixture layer 5 on each surface of the positive electrode current collector 4 to have a thickness of 75 m, and then slit processing was performed to fabricate a positive electrode plate 6.

As a negative electrode current collector 7, a porous metal body obtained by sintering copper powder was used, wherein the porous metal body had a pore size of 5 μm, a porosity of 50%, and a thickness of 25 μm. Melt impregnation of the porous metal body with polypropylene (PP) in which active carbon and calcium oxide were dispersed as a gas adsorbent 22 was performed at 160° C., and then the porous metal body was heated in a nitrogen atmosphere to 500° C. to fabricate the negative electrode current collector 7 in which the gas adsorbent 22 was adhered to a pore of the porous metal body.

The negative electrode mixture coating was applied to both surfaces of the negative electrode current collector 7, and dried to fabricate a negative electrode plate base body having a 110 μm thickness negative electrode mixture layer 8 on each surface of the negative electrode current collector 7. The negative electrode plate base body was pressed to a total thickness of 180 μm, thereby forming the negative electrode mixture layer 8 on each surface of the negative electrode current collector 7 to have a thickness of 85 μm, and then slit processing was performed to fabricate a negative electrode plate 9.

The positive electrode plate 6 and the negative electrode plate 9 which were formed as described above were used to form a secondary battery 15 in a manner similar to that of the fifth example.

### Seventh Example

A positive electrode mixture coating and a negative electrode mixture coating were prepared in a manner similar to that of the fifth example.

As a positive electrode current collector 4, a porous metal body 20 obtained by sintering nickel powder was used, wherein the porous metal body 20 had a pore size of 2 μm, a porosity of 35%, and a thickness of 30 μm. Melt impregnation of the porous metal body 20 with polyethylene (PE) in which active carbon and hydrogen-absorbing alloy were dispersed as a gas adsorbent 22 was performed at 135° C., and then the porous metal body 20 was heated in a nitrogen atmosphere to 500° C. to fabricate the positive electrode current collector 4 in which the gas adsorbent 22 was held in a pore 21 of the porous metal body 20.

The positive electrode mixture coating was applied to both surfaces of the positive electrode current collector 4, and dried to fabricate a positive electrode plate base body having a 100 μm thickness positive electrode mixture layer 5 on each surface of the positive electrode current collector 4. The positive electrode plate base body was pressed to a total thickness of 165 μm, thereby forming the positive electrode mixture layer 5 on each surface of the positive electrode current collector 4 to have a thickness of 75 μm, and then slit processing was performed to fabricate a positive electrode plate 6.

As a negative electrode current collector 7, a porous metal body obtained by sintering copper powder was used, wherein the porous metal body had a pore size of 3 μm, a porosity of 50%, and a thickness of 25 μm. Melt impregnation of the porous metal body with polypropylene (PP) in which active carbon and calcium oxide were dispersed as the gas adsorbent 22 was performed at 160° C., and then the porous metal body was heated in a nitrogen atmosphere to 500° C. to fabricate the negative electrode current collector 7 in which the gas adsorbent 22 was adhered to a pore of the porous metal body.

The negative electrode mixture coating was applied to both surfaces of the negative electrode current collector 7, and dried to fabricate a negative electrode plate base body having a 110 μm thickness negative electrode mixture layer 8 on each surface of the negative electrode current collector 7. The negative electrode plate base body was pressed to a total thickness of 180 μm, thereby forming the negative electrode mixture layer 8 on each surface of the negative electrode current collector 7 to have a thickness of 85 μm, and then slit processing was performed to fabricate a negative electrode plate 9.

The positive electrode plate 6 and the negative electrode plate 9 which were formed as described above were used to form a secondary battery 15 in a manner similar to that of the fifth example.

### Eighth Example

A secondary battery was formed in a manner similar to that of the fifth example except that a porous metal body 20 obtained by sintering nickel powder was used as a positive electrode current collector 4, where the porous metal body 20 had a pore size of 5 μm, a porosity of 35%, and a thickness of 10 μm, and silica gel and zeolite were used as a gas adsorbent 22.

### Ninth Example

A secondary battery was formed in a manner similar to that of the fifth example except that a porous metal body 20 obtained by sintering aluminum alloy powder was used as a positive electrode current collector 4, where the porous metal body 20 had a pore size of 2 μm, a porosity of 35%, and a thickness of 40 μm, and metal stearate, hydrotalcite silica gel, and zeolite were used as a gas adsorbent 22.

### Tenth Example

A secondary battery was formed in a manner similar to that of the sixth example except that a porous metal body obtained by sintering copper powder was used as a negative electrode current collector 7, where the porous metal body had a pore size of 1 μm, a porosity of 20%, and a thickness of 25 μm, and activated alumina and soda lime were used as a gas adsorbent 22.

### Eleventh Example

A secondary battery was formed in a manner similar to that of the sixth example except that a porous metal body obtained by sintering copper powder was used as a negative electrode current collector 7, where the porous metal body had a pore size of 3 μm, a porosity of 60%, and a thickness of 25 μm, and magnesium oxide, ascarite, transition metal oxide, and activated alumina were used as a gas adsorbent 22.

### Second Comparative Example

A positive electrode mixture coating and a negative electrode mixture coating were prepared in a manner similar to that of the fifth example.

The positive electrode mixture coating was applied to both surfaces of a positive electrode current collector 4 made of aluminum foil having a thickness of 15 μm, and dried to fabricate a positive electrode plate base body having a 100 μm thickness positive electrode mixture layer 5 on each surface of the positive electrode current collector 4. The positive electrode plate base body was pressed to a total thickness of 165 μm, thereby forming the positive electrode mixture layer 5 on each surface of the positive electrode current collector 4 to have a thickness of 75 μm, and then slit processing was performed to fabricate a positive electrode plate 6.

Moreover, the negative electrode mixture coating was applied to a negative electrode current collector 7 made of copper foil having a thickness of 10 μm, and dried to fabricate a negative electrode plate base body having a 110 μm thickness negative electrode mixture layer 8 on each of surfaces of the negative electrode current collector 7. The negative electrode plate base body was pressed to a total thickness of 180 μm, thereby forming the negative electrode mixture layer 8 on each surface of the negative electrode current collector 7 to have a thickness of 85 μm, and then slit processing was performed to fabricate a negative electrode plate 9.

The positive electrode plate 6 and the negative electrode plate 9 which were formed as described above were used to form a secondary battery 15 in a manner similar to that of the fifth example.

### Third Comparative Example

A secondary battery was fabricated in a manner similar to that of the fifth example except that a porous metal body 20 obtained by sintering nickel powder was used as a positive electrode current collector 4, wherein the porous metal body 20 had a pore size of 2 μm, a porosity of 35%, and a thickness of 5 μm.

### Fourth Comparative Example

A secondary battery was fabricated in a manner similar to that of the fifth example except that a porous metal body 20 obtained by sintering nickel powder was used as a positive electrode current collector 4, wherein the porous metal body 20 had a pore size of 2 μm, a porosity of 35%, and a thickness of 60 μm.

### Fifth Comparative Example

A secondary battery was fabricated in a manner similar to that of the sixth example except that a porous metal body obtained by sintering copper powder was used as a negative electrode current collector 7, wherein the porous metal body had a pore size of 3 μm, a porosity of 10%, and a thickness of 25 μm.

### Sixth Comparative Example

A secondary battery was fabricated in a manner similar to that of the sixth example except that a porous metal body obtained by sintering copper powder was used as a negative electrode current collector 7, wherein the porous metal body had a pore size of 3 μm, a porosity of 80%, and a thickness of 25 μm.

### Seventh Comparative Example

A secondary battery was fabricated in a manner similar to that of the seventh example except that a porous metal body 20 obtained by sintering nickel powder was used as a positive electrode current collector 4, wherein the porous metal body 20 had a pore size of 0.8 μm, a porosity of 35%, and a thickness of 30 μm, and a porous metal body obtained by sintering copper powder was used as a negative electrode current collector 7, wherein the porous metal body had a pore size of 0.8 μm, a porosity of 50%, and a thickness of 25 μm.

### Eighth Comparative Example

A secondary battery was fabricated in a manner similar to that of the seventh example except that a porous metal body 20 obtained by sintering nickel powder was used as a positive electrode current collector 4, wherein the porous metal body 20 had a pore size of 10 μm, a porosity of 35%, and a thickness of 30 μm, and a porous metal body obtained by sintering copper powder was used as a negative electrode current collector 7, wherein the porous metal body had a pore size of 10 μm, a porosity of 50%, and a thickness of 25 μm.

Flat laminate batteries of the fifth to eleventh examples, and the second to eighth comparative examples, 40 each, were fabricated, and the battery swelling amount, the capacity retention rate, and generated gas were evaluated in a method similar to that of the first to fourth examples, and in the first comparative example. Table 2 shows the results of the evaluation.

TABLE 2

| | Battery | Capacity | |
|---|---|---|---|
| | Swelling | Retention | |
| | Amount | Rate After | |
| | After 500 | 500 Cycles | |
| | Cycles (mm) | (%) | Generated Gas |
| 5th Example | 0.51 | 90 | H₂, CH₄, C₂H₆ |
| 6th Example | 0.60 | 91 | CO₂, CH₄, C₂H₆ |
| 7th Example | 0.33 | 93 | H₂, CO₂, CH₄, C₂H₆ |
| 8th Example | 0.66 | 92 | H₂, CO₂, CH₄ |
| 9th Example | 0.71 | 91 | H₂, CO₂, CH₄ |
| 10th Example | 0.92 | 91 | CO₂, CH₄, C₂H₆ |
| 11th Example | 0.99 | 90 | CO₂, CH₄, C₂H₆ |
| 2nd Compar. Ex. | 3.30 | 82 | H₂, CO₂, CH_{4,} C₂H₆ |
| 3rd Compar. Ex. | 2.89 | 79 | H₂, CH₄, C₂H₆ |
| 4th Compar. Ex. | 1.05 | 72 | H₂, CH₄, C₂H₆ |
| 5th Compar. Ex. | 2.71 | 78 | CO₂, CH₄, C₂H₆ |
| 6th Compar. Ex. | 3.28 | 58 | CO₂, CH₄, C₂H₆ |
| 7th Compar. Ex. | 3.11 | 80 | H₂, CO₂, CH₄, C₂H₆ |
| 8th Compar. Ex. | 2.99 | 81 | H₂, CO₂, CH₄, C₂H₆ |

Table 2 shows that in the fifth example, the battery swelling amount after the 500 cycles was reduced. This is probably because CH₄, C₂H₆, and H₂ were adsorbed by the active carbon and the hydrogen-absorbing alloy held as the gas adsorbent 22 by the positive electrode current collector 4.

In the sixth example, the battery swelling amount after the 500 cycles was reduced probably because CH₄, C₂H₆, and CO₂ were adsorbed by the active carbon and the calcium oxide held as the gas adsorbent 22 by the negative electrode current collector 7.

In the seventh example, the battery swelling amount after the 500 cycles was further reduced probably because CH₄, C₂H₆, and H₂ were adsorbed by the active carbon and the hydrogen-absorbing alloy held as the gas adsorbent 22 by the positive electrode current collector 4, and CH₄, C₂H₆, and CO₂ were adsorbed by the active carbon and the calcium oxide held as the gas adsorbent 22 by the negative electrode current collector 7.

In the eighth example, the battery swelling amount after the 500 cycles was reduced probably because CH₄, C₂H₆, and H₂ were adsorbed by the silica gel and the zeolite held as the gas adsorbent 22 by the positive electrode current collector 4.

In the ninth example, the battery swelling amount after the 500 cycles was reduced probably because CH₄, C₂H₆, and H₂ were adsorbed by the metal stearate and the hydrotalcite held as the gas adsorbent 22 by the positive electrode current collector 4.

In the tenth example, the battery swelling amount after the 500 cycles was reduced probably because CH₄, C₂H₆, and CO₂ were adsorbed by the activated alumina and the soda lime held as the gas adsorbent 22 by the negative electrode current collector 7.

In the eleventh example, the battery swelling amount after 500 cycles was reduced probably because CH₄, C₂H₆, and CO₂ were adsorbed by the magnesium oxide, the ascarite, and the transition metal oxide held as the gas adsorbent 22 by the negative electrode current collector 7.

The results of the second to eleventh examples show that when the gas adsorbent 22 is held by at least one of the positive electrode current collector 4 or the negative electrode current collector 7, the battery swelling amount can be reduced, but when the gas adsorbent 22 is held by both the positive electrode current collector 4 and the negative electrode current collector 7, maximum advantages can be obtained. Note that in the case where the gas adsorbent 22 is held by the positive electrode current collector 4, great advantages are obtained probably because the amount of gas generated from the positive electrode plate 6 is large.

Note that as the gas adsorbent 22, any material may have the sufficient effect of adsorbing gas, and a material suitable to the type of generated gas may be preferably selected.

In the second comparative example, porous metal bodies were not used as the positive electrode current collector 4 and the negative electrode current collector 7, and a gas adsorbent 22 was not held by the porous metal bodies. Thus, the second comparative example had the largest battery swelling amount after the 500 cycles.

In the third and fourth comparative examples, the battery swelling amount after the 500 cycles was larger than that in the fifth example, and the capacity retention rate after the 500 cycles was also reduced. When a porous metal body 20 having an extremely small thickness is used, the amount of the gas adsorbent 22 is small, and the strength of the positive electrode current collector 4 is insufficient, so that cracks or the like may be formed. Moreover, when a porous metal body 20 having an extremely large thickness is used, a decline in energy density per unit volume is large, so that it is difficult to increase the capacity. Thus, the thickness of the positive electrode current collector 4 is preferably in the range from 10 μm to 40 μm.

In the fifth and sixth comparative examples, the battery swelling amount after the 500 cycles is larger than that in the third example, and the capacity retention rate after the 500 cycles is reduced. When a porous metal body 20 having an extremely small porosity is used, the amount of the gas adsorbent 22 per unit volume is small, and the distribution of the gas adsorbent 22 may not be uniform. Moreover, when a porous metal body 20 having an extremely large porosity is used, the strength of the negative electrode current collector 7 is insufficient, and thus cracks or the like may be formed. Thus, the porosity of the negative electrode current collector 7 is preferably in the range from 20% to 60%.

In the seventh and eighth comparative examples, the battery swelling amount after the 500 cycles is larger than that of the fourth example, and the capacity retention rate after the 500 cycles is also reduced. When a porous metal body 20 having an extremely small pore size is used, it is difficult for particles of the gas adsorbent 22 to enter the porous metal body 20, the amount of the gas adsorbent 22 held in the porous metal body 20 is small, and the distribution of the gas adsorbent 22 may not be uniform. Alternatively, when a porous metal body 20 having an extremely large pore size is used, the strength of the negative electrode current collector 7 is insufficient, and cracks or the like may be formed. Thus, the pore size of the negative electrode current collector 7 is preferably in the range from 1 μm to 5 μm.

The present invention has been described above with reference to the preferable embodiments, but the description is not intended to limit the invention, and of course, various modification may be made. For example, in the above embodiments, the flat laminate secondary battery has been described as an example, but the present invention is applicable to cylindrical secondary batteries, rectangular secondary batteries, etc. Moreover, the electrode group 11 formed by winding the positive electrode plate 6 and the negative electrode plate 9 with the separators 10a, 10b provided between the positive electrode plate 6 and the negative electrode plate 9 has been used, but an electrode group formed by stacking the positive electrode plate 6 and the negative electrode plate 9 with the separators 10a, 10b interposed there between may be used.

### INDUSTRIAL APPLICABILITY

The present invention is useful to power sources, or the like of portable electronic devices which require increase in capacitance.

### DESCRIPTION OF REFERENCE CHARACTERS

4 Positive Electrode Current Collector
5 Positive Electrode Mixture Layer
6 Positive Electrode Plate
7 Negative Electrode Current Collector
8 Negative Electrode Mixture Layer
9 Negative Electrode Plate
10a, 10b Separator
11 Electrode Group
12 Positive Electrode Lead
13 Negative Electrode Lead
14 Exterior package
15 Secondary Battery
16 Structural Material
17 Pore
18 Gas Adsorbent
19 Gas Adsorbing Layer
20 Porous Metal Body
21 Pore
22 Gas Adsorbent

1. A secondary battery comprising:
an electrode group which is formed by winding or stacking a positive electrode plate and a negative electrode plate with a separator interposed between the positive electrode plate and the negative electrode plate, and is sealed in an exterior package together with a nonaqueous electrolyte, wherein
the positive electrode plate includes a positive electrode mixture layer formed on a positive electrode current collector,
the negative electrode plate includes a negative electrode mixture layer formed on a negative electrode current collector,
a gas adsorbing layer including a structural material made of inorganic oxide and a binder is formed on a surface of at least one of the positive electrode mixture layer or the negative electrode mixture layer, and
a gas adsorbent is held in a pore formed in the gas adsorbing layer.

2. The secondary battery of claim 1, wherein
the inorganic oxide is at least one selected from the group consisting of silica, alumina, and magnesia.

3. The secondary battery of claim 1, wherein
the gas adsorbent is at least one selected from the group consisting of silica gel, zeolite, active carbon, metal stearate, hydrotalcite, hydrogen-absorbing alloy, activated alumina, transition metal oxide, soda lime, calcium oxide, magnesium oxide, and ascarite.

4. The secondary battery of claim 1, wherein
the gas adsorbing layer has a thickness in a range from 4 μm to 20 μm.

5. A secondary battery comprising:
an electrode group which is formed by winding or stacking a positive electrode plate and a negative electrode plate with a separator interposed between the positive electrode plate and the negative electrode plate, and is sealed in an exterior package together with a nonaqueous electrolyte, wherein
the positive electrode plate includes a positive electrode mixture layer formed on a positive electrode current collector,
the negative electrode plate includes a negative electrode mixture layer formed on a negative electrode current collector,
at least one of the positive electrode current collector or the negative electrode current collector is made of a porous metal body, and
a gas adsorbent is held in a pore formed in the porous metal body.

6. The secondary battery of claim 5, wherein
the porous metal body has a thickness in a range from 10 μm to 40 μm.

7. The secondary battery of claim 5, wherein
the porous metal body has a porosity in a range from 20% to 60%.

8. The secondary battery of claim 5, wherein
the porous metal body has a pore size in a range from 1 μm to 5 μm.

9. The secondary battery of claim 5, wherein
the gas adsorbent is at least one selected from the group consisting of silica gel, zeolite, active carbon, metal stearate, hydrotalcite, hydrogen-absorbing alloy, activated alumina, transition metal oxide, soda lime, calcium oxide, magnesium oxide, and ascarite.
